(19) United States
(12) Patent Application Publication
(10) Pub. No.: US 2026/0128531 A1
(43) Pub. Date: May 7, 2026

(54) ANTENNA SYSTEM

(71) Applicant: HUAWEI TECHNOLOGIES CO., LTD., Shenzhen (CN)

(72) Inventors: Ning Yang, Shenzhen (CN); Chuanhui Ma, Chengdu (CN); Bo Yang, Chengdu (CN); Meng Cai, Chengdu (CN)

(73) Assignee: HUAWEI TECHNOLOGIES CO., LTD., Shenzhen (CN)

(21) Appl. No.: 19/426,348

(22) Filed: Dec. 19, 2025

Related U.S. Application Data
(63) Continuation of application No. PCT/CN2024/092140, filed on May 10, 2024.

(30) Foreign Application Priority Data
Jun. 21, 2023 (CN) 202310743396.8

(51) Int. Cl. H01Q 19/12; H01Q 5/30; H01Q 19/06

(52) U.S. Cl. CPC H01Q 19/12; H01Q 5/30; H01Q 19/06

(57) ABSTRACT

An antenna system includes a first radiation source, a second radiation source, a reflection apparatus, and a first transmission apparatus. A direction of an emitting port of the first radiation source and a direction of an emitting port of the second radiation source are arranged back to back along a same axis. A reflective surface of the reflection apparatus and the first transmission apparatus are arranged opposite to each other. The reflection apparatus is configured to reflect the first signal emitted by the first radiation source to a ring-shaped transmission area of the first transmission apparatus by using the reflective surface. The first transmission apparatus is configured to radiate, through the ring-shaped transmission area, the first signal reflected by the reflective surface. The second radiation source is configured to emit a second signal through an area formed based on an inner diameter of the ring-shaped transmission area.

### CROSS-REFERENCE TO RELATED APPLICATIONS

This application is a continuation of International Application No. PCT/CN2024/092140, filed on May 10, 2024, which claims priority to Chinese Patent Application No. 202310743396.8, filed on June 21, 2023. The disclosures of the aforementioned applications are hereby incorporated by reference in their entireties.

### TECHNICAL FIELD

Embodiments of this application relate to the communication field, and in particular, to an antenna system.

### BACKGROUND

With rapid development of wireless communication technologies, data traffic at an access network side is increasing. Wireless transfer channels between an access network and an aggregation network need further capacity expansion to meet continuous growth of data services, and advantages of large bandwidths of high frequency bands are increasingly recognized. Therefore, high frequency bands represented by millimeter waves are gradually becoming used for microwave backhaul. However, although millimeter waves have the advantage of large bandwidths, millimeter waves also face greater atmospheric attenuation, which may affect communication distances of backhaul links. Therefore, dual-emitting-port antennas may be used to transfer different signals, improving communication efficiency or capacity, thereby improving communication performance of long-range wireless backhaul.

However, in conventional technologies, signals emitted from two emitting ports of a dual-emitting-port antenna may be coupled, and poorly isolated. This may affect radiation efficiency of the signals generated by the emitting ports, and may further affect radiation efficiency of the antenna system.

### SUMMARY

This application provides an antenna system, to radiate, in a same aperture and with mutually independent radiation paths, signals from different emitting ports, thereby improving radiation efficiency of the antenna system.

According to a first aspect, this application provides an antenna system. The antenna system includes a first radiation source, a second radiation source, a reflection apparatus, and a first transmission apparatus. A direction of an emitting port of the first radiation source and a direction of an emitting port of the second radiation source are arranged back to back along a same axis, a reflective surface of the reflection apparatus and the first transmission apparatus are arranged opposite to each other, the emitting port of the first radiation source points to the reflective surface of the reflection apparatus, and the first transmission apparatus has a ring-shaped transmission area. During use, the first radiation source is configured to emit a first signal to the reflective surface of the reflection apparatus. The reflection apparatus is configured to reflect the first signal to the ring-shaped transmission area of the first transmission apparatus by using the reflective surface. The first transmission apparatus is configured to radiate, out of the antenna system through the ring-shaped transmission area, the first signal reflected by the reflective surface. The second radiation source is configured to emit a second signal, where the second signal is radiated out of the antenna system through an area formed based on an inner diameter of the ring-shaped transmission area.

In this application, the direction of the emitting port of the first radiation source and the direction of the emitting port of the second radiation source are arranged back to back along the same axis, and the two radiation sources perform emission in directions away from each other along the same axis. After being reflected by the reflection apparatus, the first signal emitted by the first radiation source is transmitted out of the antenna system through the ring-shaped transmission area of the first transmission apparatus. In addition, the second radiation source emits the second signal in a direction opposite to the direction of the emitting port of the first radiation source, and radiates the second signal out of the antenna system through the area formed based on the inner diameter of the ring-shaped transmission area. Therefore, the first signal and the second signal that are finally radiated from the antenna system are radiated in a same aperture and with mutually independent radiation paths. This helps avoid strong coupling between the signals (the first signal and the second signal) emitted from different radiation ports, achieves high isolation, and helps improve radiation efficiency of the signals (the first signal and the second signal) generated by different radiation sources.

In some embodiments, that a wavelength of the first signal is different from a wavelength of the second signal may be that the first signal and the second signal respectively belong to different frequency bands. When the wavelength of the first signal is different from the wavelength of the second signal or the first signal and the second signal respectively belong to different frequency bands, the antenna system implements radiating, in a same aperture and with mutually independent radiation paths, the signals in different frequency bands. This has an advantage of reducing an antenna aperture, helps avoid strong coupling between the signals in different frequency bands and generated by different radiation sources, achieves high isolation, and helps improve radiation efficiency of the signals in different frequency bands and generated by different radiation sources.

In some embodiments, the first radiation source is a microwave radiation source, the first signal is a microwave, the second radiation source is a free space optical radiation source, and the second signal is wireless light.

Because wireless light and microwave signals have opposite channel characteristics, for example, wireless light has an advantage of increased resistance to rain attenuation, and microwave signals have lower levels of fog attenuation and snow attenuation, hybrid networking of microwave signals and wireless light advantageously achieve channel complementarity, and improve communication performance of long-range wireless backhaul. In addition, because the microwave radiation source and the free space optical radiation source share an aperture, and radiation paths are mutually independent, the communication performance of long-range wireless backhaul can be further improved while the benefit of channel complementarity is retained.

In another possible implementation, both the first radiation source and the second radiation source are microwave radiation sources, and both the first signal and the second signal are microwaves.

The antenna system may be used to radiate, in a same aperture and with mutually independent radiation paths, microwaves emitted from different emitting ports. When the wavelength of the first signal is different from the wavelength of the second signal, a capacity of a communication system can be increased. When the wavelength of the first signal is the same as the wavelength of the second signal, a capacity of a communication system can be increased, and spectral efficiency can be improved, thereby implementing full-duplex communication.

In some embodiments, the wavelength of the first signal emitted by the first radiation source is greater than the wavelength of the second signal emitted by the second radiation source.

In some embodiments, to meet a specular reflection condition, roughness of the reflective surface is generally required to be one tenth of a wavelength. To reduce manufacturing difficulty of the reflection apparatus, the first signal with a relatively long wavelength, rather than the second signal with a relatively short wavelength, is configured to be reflected by the reflection apparatus. This helps reduce manufacturing difficulty of the reflective surface of the reflection apparatus.

In some embodiments, the reflective surface is a surface of a solid of revolution formed by rotating a first curve with the axis as a rotation center, and the emitting port of the first radiation source is located at a focus of the first curve.

In some embodiments, the first signal emitted by the first radiation source to the reflective surface along the axis diverges outward along the axis and is centrosymmetric with respect to the axis, and a transfer path of the first signal after the first signal is reflected by the reflective surface is also centrosymmetric with respect to the axis. Therefore, the reflected first signal can match the ring-shaped transmission area of the first transmission apparatus, so that the reflected first signal can be smoothly radiated out of the antenna system through the ring-shaped transmission area.

In some embodiments, the first curve is a part of an elliptic curve.

In some embodiments, the emitting port of the first radiation source is located at a first focus of the elliptic curve, and the first signal emitted by the first radiation source passes through a second focus of the elliptic curve after being reflected by the reflective surface.

Because a sum of distances from any point on the elliptic curve to the two focuses of the elliptic curve is a fixed value, after beams emitted from one of the focuses of the elliptic curve in various directions are reflected on the elliptic curve and pass through the other focus, lengths of optical paths of the foregoing plurality of beams are the same. Therefore, this helps control wavefronts radiated out of the antenna system to be the same.

In some embodiments, the first transmission apparatus is configured to project the first signal reflected by the reflective surface into a collimated signal, and a focus of the first transmission apparatus coincides with the second focus of the elliptic curve.

This is helpful for secondary radiation of the first signal passing through the second focus, similar to a point source, so that the first signal is radiated out of the antenna system in a collimated manner. This helps increase a propagation distance of the first signal after the first signal is radiated out of the antenna system.

In some embodiments, the antenna system further includes a second transmission apparatus, the second transmission apparatus is located in the area formed based on the inner diameter of the first transmission apparatus, the emitting port of the second radiation source is located at a focus of the second transmission apparatus, and the second transmission apparatus is configured to project the second signal emitted by the second radiation source into a collimated signal.

In some embodiments, the second signal can be radiated out of the antenna system in a collimated manner. This helps increase a propagation distance of the second signal after the second signal is radiated out of the antenna system.

In some embodiments, the antenna system further includes a first support apparatus, the first support apparatus is configured to support the reflection apparatus and the first transmission apparatus respectively by using two end surfaces that are arranged opposite to each other, the reflection apparatus is located on a first end surface in the two end surfaces that are arranged opposite to each other, the first transmission apparatus is located on a second end surface in the two end surfaces that are arranged opposite to each other, and a periphery of the first transmission apparatus is connected to a periphery of the second end surface.

In some embodiments, the reflection apparatus and the first transmission apparatus are fastened by using the first support apparatus. This helps maintain a stable structure of the antenna system, and avoid impact on radiation efficiency of the first signal and the second signal caused because radiation paths change.

In some embodiments, the antenna system further includes a second support apparatus, and the second support apparatus is configured to support the first radiation source and the second radiation source to be coaxial.

In some embodiments, the second support apparatus is configured to keep the first radiation source and the second radiation source coaxial, so that the reflected first signal does not overflow from the ring-shaped transmission area of the first transmission apparatus, and the second signal emitted by the second radiation source does not overflow from the area formed based on the inner diameter of the ring-shaped transmission area. This helps improve isolation between the first signal and the second signal, and further improve radiation efficiency of the antenna system.

In some embodiments, the first support apparatus is a cylindrical housing, a bowl-shaped housing, or a disc-shaped housing.

The first support apparatus may be configured as a cylindrical housing, a bowl-shaped housing, a disc-shaped housing, or the like. This helps protect the first radiation source and the second radiation source in the antenna system, and avoid interference caused by external factors such as wind and rain to the radiation sources.

In some embodiments, the first transmission apparatus includes any one of a dielectric lens, a planar lens, and a metamaterial lens.

In some embodiments, the second transmission apparatus includes any one of a plano- convex lens, a Cassegrain lens, and a Gregorian lens.

### BRIEF DESCRIPTION OF DRAWINGS

FIG. 1A is a diagram of an embodiment of an antenna system according to this application;

FIG. 1B is a diagram of another embodiment of an antenna system according to this application;

FIG. 2A is an example diagram of a reflection apparatus according to this application;

FIG. 2B is another example diagram of a reflection apparatus according to this application;

FIG. 3 is a diagram of another embodiment of an antenna system according to this application;

FIG. 4 is a diagram of an embodiment of a support apparatus according to this application;

FIG. 5 is a diagram of another embodiment of an antenna system according to this application;

FIG. 6A is an example diagram of a simulation result of an antenna system according to this application;

FIG. 6B is another example diagram of a simulation result of an antenna system according to this application;

FIG. 7A is an example diagram of a communication module according to this application; and

FIG. 7B is another example diagram of a communication module according to this application.

### DESCRIPTION OF EMBODIMENTS

The following describes the technical solutions in embodiments of this application with reference to the accompanying drawings in embodiments of this application. It is clear that the described embodiments are merely some but not all of embodiments of this application.

In the specification, claims, and accompanying drawings of this application, the terms "first", "second", "third", "fourth", and the like (if existent) are intended to distinguish between similar objects but do not necessarily indicate a specific order or sequence. It should be understood that the terms used in such a way are interchangeable in proper circumstances, so that embodiments described herein can be implemented in an order other than the order illustrated or described herein. In addition, the terms "include" and "have" and any other variants are intended to cover the non-exclusive inclusion. For example, a process, method, system, product, or device that includes a list of operations or units is not necessarily limited to those expressly listed operations or units, but may include other operations or units not expressly listed or inherent to such a process, method, product, or device.

It should be understood that the term "and/or" in this specification describes only an association relationship between associated objects and indicates that three relationships may exist. For example, A and/or B may indicate the following three cases: Only A exists, both A and B exist, and only B exists. In addition, the character "/" in this specification generally indicates an "or" relationship between the associated objects.

This application provides an antenna system, to radiate, in a same aperture and with mutually independent radiation paths, signals from different emitting ports, thereby improving radiation efficiency of the antenna system.

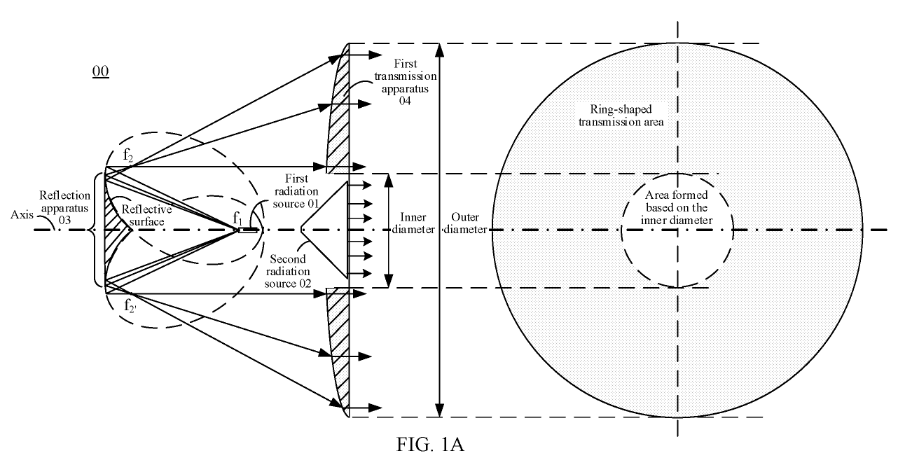

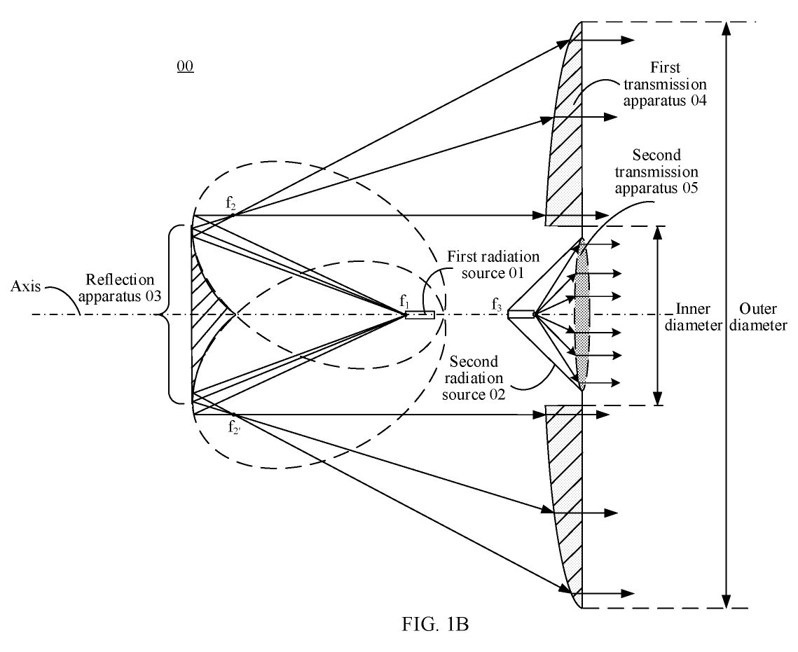

FIG. 1A is a diagram of an embodiment of an antenna system 00 according to this application.

As shown in a sectional view of the antenna system 00 on the left side in FIG. 1A, the antenna system 00 includes a first radiation source 01, a second radiation source 02, a reflection apparatus 03, and a first transmission apparatus 04.

The first radiation source 01 and the second radiation source 02 are separately configured to emit a communication signal. A direction of an emitting port of the first radiation source 01 and a direction of an emitting port of the second radiation source 02 are arranged back to back along a same axis. In other words, the direction of the emitting port of the first radiation source 01 and the direction of the emitting port of the second radiation source 02 are arranged to be opposite along the same axis, and signals emitted by the first radiation source 01 and the second radiation source 02 are away from each other. For example, the emitting port of the first radiation source 01 in FIG. 1A is placed leftward along the axis, and the emitting port of the second radiation source 02 in FIG. 1A is placed rightward along the axis. When the first radiation source 01 and the second radiation source 02 operate, a signal emitted by the first radiation source 01 (referred to as a first signal below) is radiated leftward, in other words, emitted along the axis in a direction away from the second radiation source 02; and a signal emitted by the second radiation source (referred to as a second signal below) is radiated rightward, in other words, emitted along the axis in a direction away from the first radiation source 01.

In addition, a reflective surface of the reflection apparatus 03 and the first transmission apparatus 04 are arranged opposite to each other. The reflection apparatus 03 is located on an emitting port side of the first radiation source 01, and the first transmission apparatus 04 is located on an emitting port side of the second radiation source 02. The emitting port of the first radiation source 01 points to the reflective surface of the reflection apparatus 03, so that, after being reflected by the reflection apparatus 03, the first signal emitted by the first radiation source 01 can be radiated in a direction in which the first transmission apparatus 04 is located. In some embodiments, the reflection apparatus 03, the first radiation source 01, the second radiation source 02, and the first transmission apparatus 04 are coaxial.

In addition, as shown in a side view of the first transmission apparatus 04 on the right side in FIG. 1A, the first transmission apparatus 04 has a ring-shaped transmission area (an area formed by extending from an inner diameter to an outer diameter). The ring-shaped transmission area is made of a transparent medium. The first signal can pass through the ring-shaped transmission area, in other words, the first signal reflected by the reflective surface of the reflection apparatus 03 can be radiated out of the antenna through the ring-shaped transmission area after arriving at the ring-shaped transmission area. In addition, the second signal can pass through an area formed based on the inner diameter of the ring-shaped transmission area, and the first signal does not pass through the area formed based on the inner diameter of the first transmission structure 04. The area formed based on the inner diameter may be made of a transparent medium, or may be hollow. For example, if the area formed based on the inner diameter is hollow, the first transmission apparatus 04 is a ring-shaped lens. If the area formed based on the inner diameter is made of a transparent medium, the first transmission apparatus 04 is a multi-structure lens. For example, the first transmission apparatus 04 may be implemented by using any one of a dielectric lens, a planar lens, a metamaterial lens, and the like.

For example, when the antenna system 00 operates, the first radiation source 01 emits the first signal to the reflective surface of the reflection apparatus 03. The reflection apparatus 03 reflects the first signal to the ring-shaped transmission area of the first transmission apparatus 04 by using the reflective surface. The first transmission apparatus 04 radiates, out of the antenna system 00 through the ring-shaped transmission area, the first signal reflected by the reflective surface. In addition, the second radiation source 02 emits the second signal, where the second signal is radiated out of the antenna system 00 through the area formed based on the inner diameter of the ring-shaped transmission area.

In an embodiment, the direction of the emitting port of the first radiation source 01 and the direction of the emitting port of the second radiation source 02 are arranged back to back along the same axis, and the two radiation sources perform emission in directions away from each other along the same axis. After being reflected by the reflection apparatus 03, the first signal emitted by the first radiation source 01 is transmitted out of the antenna system 00 through the ring-shaped transmission area of the first transmission apparatus 04. In addition, the second radiation source 02 emits the second signal in a direction opposite to the direction of the emitting port of the first radiation source 01, and radiates the second signal out of the antenna system 00 through the area formed based on the inner diameter of the ring-shaped transmission area. Therefore, the first signal and the second signal that are finally radiated from the antenna system 00 are radiated in a same aperture and with mutually independent radiation paths. This helps avoid strong coupling between the signals (the first signal and the second signal) emitted from different radiation ports, achieves high isolation, and helps improve radiation efficiency of the signals (the first signal and the second signal) generated by different radiation sources.

In some embodiments, that a wavelength of the first signal is different from a wavelength of the second signal may also be understood as that the first signal and the second signal respectively belong to different frequency bands. When the wavelength of the first signal is different from the wavelength of the second signal or the first signal and the second signal respectively belong to different frequency bands, the antenna system 00 implements radiating, in a same aperture and with mutually independent radiation paths, the signals in different frequency bands. This has an advantage of reducing an antenna aperture, helps avoid strong coupling between the signals in different frequency bands and generated by different radiation sources, achieves high isolation, and helps improve radiation efficiency of the signals in different frequency bands and generated by different radiation sources.

It should be noted that after the first signal and the second signal are radiated out of the antenna system 00, a radiation direction of the second signal may be the same as or different from a radiation direction of the first signal. This is not limited in this application.

In some embodiments, as shown in FIG. 1B, an antenna system 00 further includes a second transmission apparatus 05. The second transmission apparatus 05 is located in an area formed based on an inner diameter of a ring-shaped transmission area of a first transmission apparatus 04. In other words, a diameter of the second transmission apparatus 05 is less than or equal to the inner diameter of the ring-shaped transmission area of the first transmission apparatus 04. In some embodiments, the first transmission apparatus 04 and the second transmission apparatus 05 are coaxial. In some embodiments, the first transmission apparatus 04 and the second transmission apparatus 05 are coplanar. In some embodiments, an emitting port of a second radiation source 04 is located at a focus of the second transmission apparatus 05, and the second transmission apparatus 05 is configured to project a second signal emitted by the second radiation source 02 into a collimated signal. In some embodiments, the second transmission apparatus 05 is further configured to perform beam expansion processing on the second signal emitted by the second radiation source 02. For example, the second transmission apparatus 05 may be implemented by using any one of a plano-convex lens, a Cassegrain lens, a Gregorian lens, and the like.

It should be noted that the first transmission apparatus 04 and the second transmission apparatus 05 may be implemented in an integrated form, for example, a function of the first transmission apparatus 04 and a transmission function of the second transmission apparatus 05 are integrated into one multi-structure lens. For example, the area formed based on the inner diameter of the first transmission apparatus 04 is not hollow, the ring-shaped transmission area of the first transmission apparatus 04 is made of a transparent medium, and the area formed based on the inner diameter of the ring-shaped transmission area is also made of a transparent medium. In addition, a focal length of the ring-shaped transmission area is different from a focal length of the area formed based on the inner diameter of the ring-shaped transmission area. For example, the focal length of the ring-shaped transmission area is configured to cause a first signal reflected by a reflective surface to be radiated out of the antenna system 00 in a collimated manner, and the focal length of the area formed based on the inner diameter of the ring-shaped transmission area is configured to cause the second signal emitted by the second radiation source 02 to be radiated out of the antenna system 00 in a collimated manner.

Further, the following describes a structure of the reflection apparatus 03 in an embodiment.

In this application, the reflective surface is a surface of a solid of revolution formed by rotating a first curve with the axis as a rotation center. The emitting port of the first radiation source 01 is located at a focus of the first curve, the first signal emitted by the first radiation source 01 to the reflective surface along the axis diverges outward along the axis and is centrosymmetric with respect to the axis, and a transfer path of the first signal after the first signal is reflected by the reflective surface is also centrosymmetric with respect to the axis.

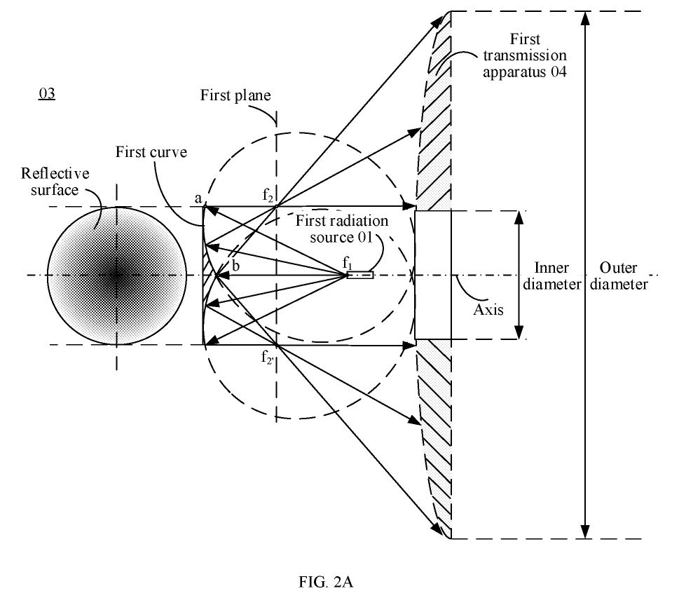

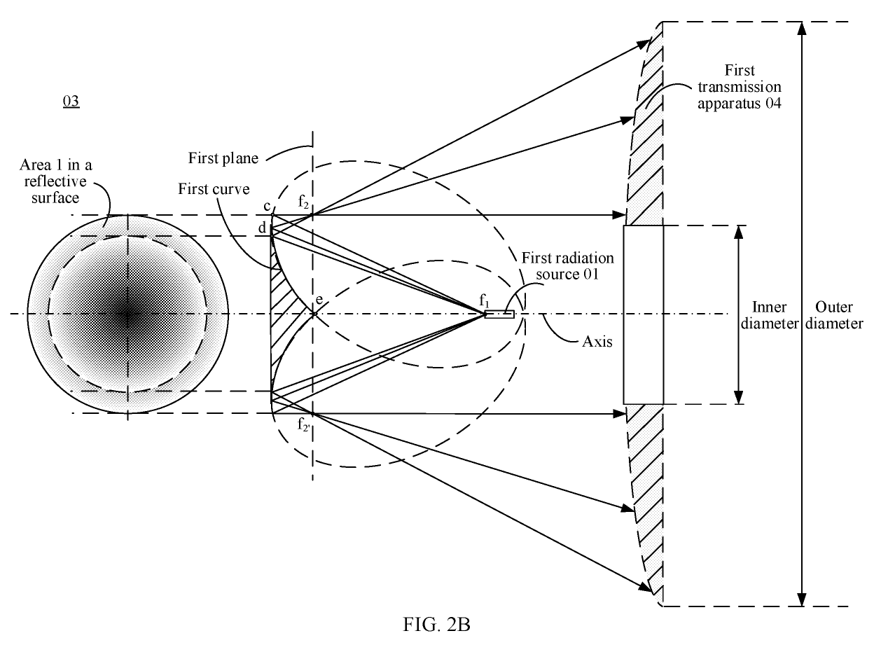

In some embodiments, as shown in FIG. 2A or FIG. 2B, the first curve is a part of an elliptic curve. The emitting port of the first radiation source 01 is located at a first focus (namely, f₁) of the elliptic curve, and the first signal emitted by the first radiation source 01 passes through a second focus (namely, f₂) of the elliptic curve after being reflected by the reflective surface. Because a sum of distances from any point on the elliptic curve to the two focuses of the elliptic curve is a fixed value, after beams emitted from one of the focuses of the elliptic curve in various directions are reflected on the elliptic curve and pass through the other focus, lengths of optical paths of the foregoing plurality of beams are the same. Therefore, this helps control wavefronts radiated out of the antenna system to be the same.

Because the first signal emitted by the first radiation source 01 is a conical beam signal, the reflective surface is a surface of a solid of revolution formed by rotating the first curve with the axis as a rotation center, and the first signal passes through the second focus (namely, f₂) of the elliptic curve after being reflected by the reflective surface, the first signal reflected by the reflective surface forms a circle in a first plane perpendicular to the axis (a plane through the second focus and perpendicular to the axis). After passing through the first plane, the first signal reflected by the reflective surface continues to be radiated in the direction in which a first transmission apparatus 04 is located. In addition, as shown in FIG. 2A or FIG. 2B, a focus of the first transmission apparatus 04 coincides with the second focus of the elliptic curve. Therefore, the first signal arriving at the first transmission apparatus 04 is to be radiated out of the antenna system 00 in a collimated manner. It may also be understood as that, the reflection apparatus 03 converts, into countless point sources through reflection of the reflective surface, a spherical wave radiated by the first radiation source 01 in a point manner, and the countless point sources are arranged in a ring shape. Then, the equivalent countless point sources on a circular ring are radiated secondarily through the ring-shaped transmission area of the first transmission apparatus 04, and further radiated from the aperture of the antenna system 00.

In an example, parameters (for example, a major axis and a minor axis) of the elliptic curve, an included angle between the major axis of the elliptic curve and the axis (namely, the axis of the antenna system 00), and a distance between a geometric center of the first transmission apparatus 04 and the emitting port of the first radiation source 01 are adjusted, so that the first signal emitted by the first radiation source 01 entirely arrives in the ring-shaped transmission area of the first transmission apparatus 04 after being reflected by the reflective surface. For example, as shown in FIG. 2A, the first curve is a curve segment ab, an endpoint b of the first curve intersects with the axis, and the reflective surface is a regular curved surface that is convex in the middle and concave around the middle. The first signal emitted by the first radiation source 01 is a conical beam signal. A beam in the first signal and having a smallest included angle with the axis (namely, a beam in the first signal and propagated along the axis) points to the endpoint b. The beam pointing to the endpoint b is reflected after arriving at the endpoint b, passes through the focus f₂, and then arrives at an edge that is of the ring-shaped transmission area of the first transmission apparatus 04 and that is close to the outer diameter. A beam in the first signal and having a largest included angle with the axis points to an endpoint a, and a path along which the beam pointing to the endpoint a is reflected after the beam arrives at the endpoint a is parallel to the axis. The beam passes through the focus f2, and then arrives at an edge that is of the ring-shaped transmission area of the first transmission apparatus 04 and that is close to the inner diameter. In this example, the entire reflective surface formed based on the curve segment ab can receive the beam in the first signal and reflect the beam in the first signal.

In this example, proper parameters (for example, a proper major axis and a proper minor axis) of the elliptic curve, a proper included angle between the major axis of the elliptic curve and the axis (namely, the axis of the antenna system 00), and a proper distance between the geometric center of the first transmission apparatus 04 and the emitting port of the first radiation source 01 are configured, so that the first signal emitted by the first radiation source 01 entirely arrives in the ring-shaped transmission area of the first transmission apparatus 04 after being reflected by the reflective surface, and does not overflow to outside of the outer diameter of the ring-shaped transmission area, nor overflow to inside of the inner diameter of the ring-shaped transmission area. This helps improve radiation efficiency of the first signal emitted by the first radiation source 01.

In another example, in addition to adjusting parameters (for example, a major axis and a minor axis) of the elliptic curve, an included angle between the major axis of the elliptic curve and the axis (namely, the axis of the antenna system 00), and a distance between a geometric center of the first transmission apparatus 04 and the emitting port of the first radiation source 01, a shape of the first signal emitted by the first radiation source 01 may be further adjusted, in other words, the first signal is configured as a hollow beam that diverges conically, so that the first signal emitted by the first radiation source 01 entirely arrives in the ring-shaped transmission area of the first transmission apparatus 04 after being reflected by the reflective surface. For example, as shown in FIG. 2B, the first curve is a curve segment cde, an endpoint e of the first curve intersects with the axis, and the reflective surface is a regular curved surface that is convex in the middle and concave around the middle. The first signal emitted by the first radiation source 01 along the axis is a hollow beam that diverges conically, and an area of the beam on a cross section perpendicular to the axis is a circular ring. There is no beam propagated along the axis in the first signal. A beam in the first signal and having a smallest included angle with the axis points to an endpoint d. After arriving at the endpoint d, the beam passes through the focus f₂, and then arrives at an edge that is of the ring-shaped transmission area of the first transmission apparatus 04 and that is close to the outer diameter. A beam in the first signal and having a largest included angle with the axis points to an endpoint c, and a path along which the beam pointing to the endpoint c is reflected after the beam arrives at the endpoint c is parallel to the axis. The beam passes through the focus f₂, and then arrives at an edge that is of the ring-shaped transmission area of the first transmission apparatus 04 and that is close to the inner diameter. In this example, in the curve segment cde, only a ring-like area (namely, an area 1 in the reflective surface) corresponding to a curve segment cd can receive the beam in the first signals and reflect the beam in the first signals.

In this example, a beam shape of the first signal is adjusted, so that the first signal emitted by the first radiation source 01 entirely arrives in the ring-shaped transmission area of the first transmission apparatus 04 after being reflected by the reflective surface, and does not overflow to outside of the outer diameter of the ring-shaped transmission area, nor overflow to inside of the inner diameter of the ring-shaped transmission area. This helps the first radiation source 01 flexibly adapt to the antenna system 00, and further helps improve radiation efficiency of the first signal emitted by the first radiation source 01.

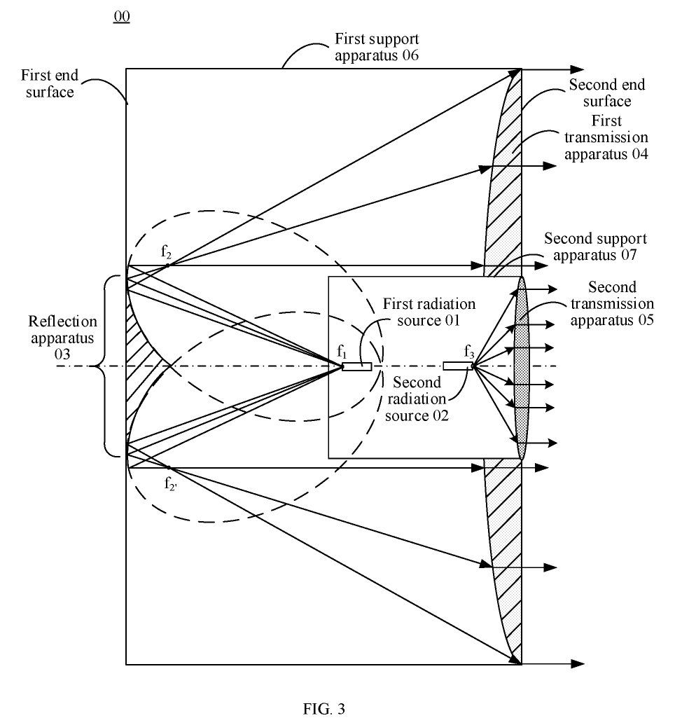

Further, the following describes support apparatuses related to the antenna system 00 with reference to FIG. 3.

As shown in FIG. 3, the antenna system 00 further includes a first support apparatus 06. The first support apparatus 60 is configured to support the reflection apparatus 03 and the first transmission apparatus 04 respectively by using two end surfaces that are arranged opposite to each other. The reflection apparatus 03 is located on a first end surface (an end surface close to the first radiation source 01) in the two end surfaces that are arranged opposite to each other, and the first transmission apparatus 04 is located on a second end surface (an end surface close to the second radiation source 02) in the two end surfaces that are arranged opposite to each other. In some embodiments, a diameter of the reflective surface of the reflection apparatus 03 is less than or equal to a diameter of the first end surface, and the outer diameter of the first transmission apparatus is less than or equal to a diameter of the second end surface. For example, a periphery of the first transmission apparatus 04 is connected to a periphery of the second end surface.

In some embodiments, the first support apparatus 06 is a cylindrical housing, a bowl-shaped housing, or a disc-shaped housing, or may be a support structure of another shape. This is not limited herein. For example, the cylindrical housing may be a cylinder, or may be a polygonal cylinder (for example, a 12-sided cylinder or a 16-sided cylinder).

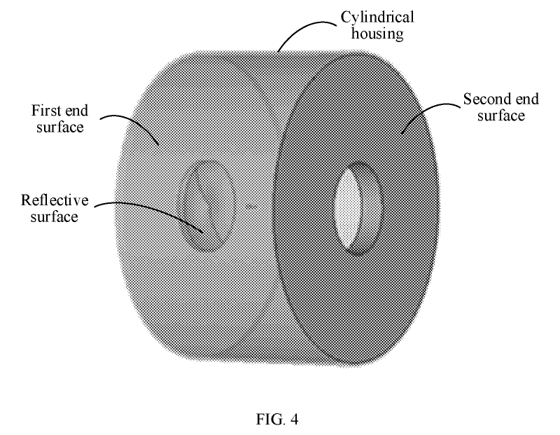

As shown in FIG. 4, an example in which the first support apparatus 06 is a cylinder is used. The cylinder has a first end surface and a second end surface that are arranged opposite to each other, and both the first end surface and the second end surface are perpendicular to an axis of the cylinder. The first end surface (an end surface close to the first radiation source 01) of the cylinder is used to configure the reflection apparatus 03, and the second end surface (an end surface close to the second radiation source 02) of the cylinder is used to configure the first transmission apparatus 04. A circle determined based on the outer diameter of the first transmission apparatus 04 coincides with and is connected to a circle determined based on a diameter of the second end surface.

In some embodiments, the reflection apparatus and the first transmission apparatus are fastened by using the first support apparatus. This helps maintain a stable structure of the antenna system, and avoid impact on radiation efficiency of the first signal and the second signal caused because radiation paths change. In addition, the first support apparatus is configured as a cylindrical housing, a bowl-shaped housing, a disc-shaped housing, or the like. This helps protect the first radiation source and the second radiation source in the antenna system, and avoid interference caused by external factors such as wind and rain to the radiation sources.

In some embodiments, as shown in FIG. 3, the antenna system 00 further includes a second support apparatus 07. The second support apparatus 07 is configured to support the first radiation source 01 and the second radiation source 02 to be coaxial. In some embodiments, an end surface that is of the second support apparatus 07 and that is close to the second radiation source 02 is configured to support the second transmission apparatus 05. In some embodiments, the second support apparatus 07 may be a cylindrical housing, or may be a support structure of another shape. This is not limited herein. For example, the cylindrical housing may be a cylinder, or may be a polygonal cylinder (for example, a 12-sided cylinder or a 16-sided cylinder). As shown in FIG. 3, an example in which the second support apparatus 07 is a cylinder is used. The cylinder and an axis are coaxial. The cylinder is configured to accommodate the first radiation source 01 and the second radiation source 02, an end surface close to the second radiation source 02 is configured to support the second transmission apparatus 05, and a length of a generatrix of the cylinder is greater than a focal length of the second transmission apparatus 05.

In some embodiments, the second support apparatus is configured to keep the first radiation source and the second radiation source coaxial, so that the reflected first signal does not overflow from the ring-shaped transmission area of the first transmission apparatus, and the second signal emitted by the second radiation source does not overflow from the area formed based on the inner diameter of the ring-shaped transmission area. This helps improve isolation between the first signal and the second signal, and further improve radiation efficiency of the antenna system.

Further, the first radiation source 01 and the second radiation source 02 may be implemented in a plurality of manners, which are separately described below.

In some embodiments, the first radiation source 01 is a microwave radiation source, the second radiation source 02 is a free space optical (FSO) radiation source, the first signal is a microwave, and the second signal is wireless light. For example, the microwave may be a millimeter wave, a centimeter wave, a terahertz (THz) wave, or the like. This is not limited herein. For example, the wireless light may be an infrared laser, visible light, or the like.

In some embodiments, because wireless light and microwave have opposite channel characteristics, in other words, wireless light has an advantage of stronger resistance to rain attenuation, and microwave has lower levels of fog attenuation and snow attenuation, hybrid networking of microwave and wireless light can achieve a benefit of channel complementarity, and improve communication performance of long-range wireless backhaul. In addition, because the microwave radiation source and the free space optical radiation source share an aperture, and radiation paths are mutually independent, the communication performance of long-range wireless backhaul can be further improved while the benefit of channel complementarity is retained.

In another possible implementation, both the first radiation source 01 and the second radiation source 02 are microwave radiation sources. Both the first signal and the second signal are microwaves.

In some embodiments, the antenna system 00 is used to radiate, in a same aperture and with mutually independent radiation paths, microwaves emitted from different emitting ports. When the wavelength of the first signal is different from the wavelength of the second signal, a capacity of a communication system can be increased. When the wavelength of the first signal is the same as the wavelength of the second signal, a capacity of a communication system can be increased, and spectral efficiency can be improved, thereby implementing full-duplex communication.

In some embodiments, the wavelength of the first signal emitted by the first radiation source 01 is greater than the wavelength of the second signal emitted by the second radiation source 02.

In some embodiments, to meet a specular reflection condition, roughness of the reflective surface is generally required to be one tenth of a wavelength. To reduce manufacturing difficulty of the reflection apparatus 03, the first signal with a relatively long wavelength, rather than the second signal with a relatively short wavelength, is configured to be reflected by the reflection apparatus 03. This helps reduce manufacturing difficulty of the reflective surface of the reflection apparatus 03.

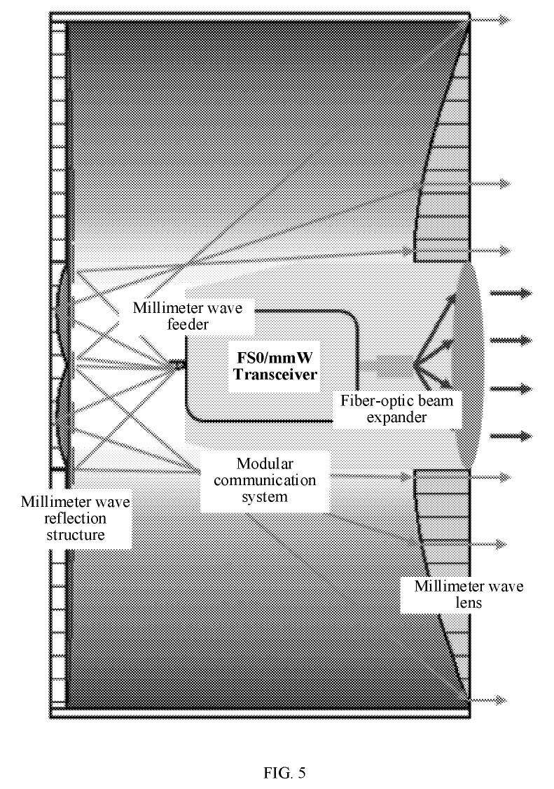

For ease of understanding, as shown in FIG. 5, an example in which the first radiation source 01 is a millimeter wave feeder and the second radiation source 02 is a free space optical radiation source is used for description. In the example shown in FIG. 5, the millimeter wave feeder emits a millimeter wave to a millimeter wave reflection structure deployed at a back end (that is, an example of the reflective surface of the reflection apparatus 03 described above). After being reflected by the millimeter wave reflection structure, the millimeter wave arrives at a ring-shaped millimeter wave lens deployed at a front end (that is, an example of the first transmission apparatus 04 described above), and is radiated out of the antenna system through the ring-shaped millimeter wave lens. In addition, the free space optical radiation source emits wireless light to a fiber-optic beam expander (that is, an example of the second transmission apparatus 05 described above) that is located at a hollow center of the millimeter wave lens. The wireless light is radiated out of the antenna system after being collimated and expanded by the fiber-optic beam expander.

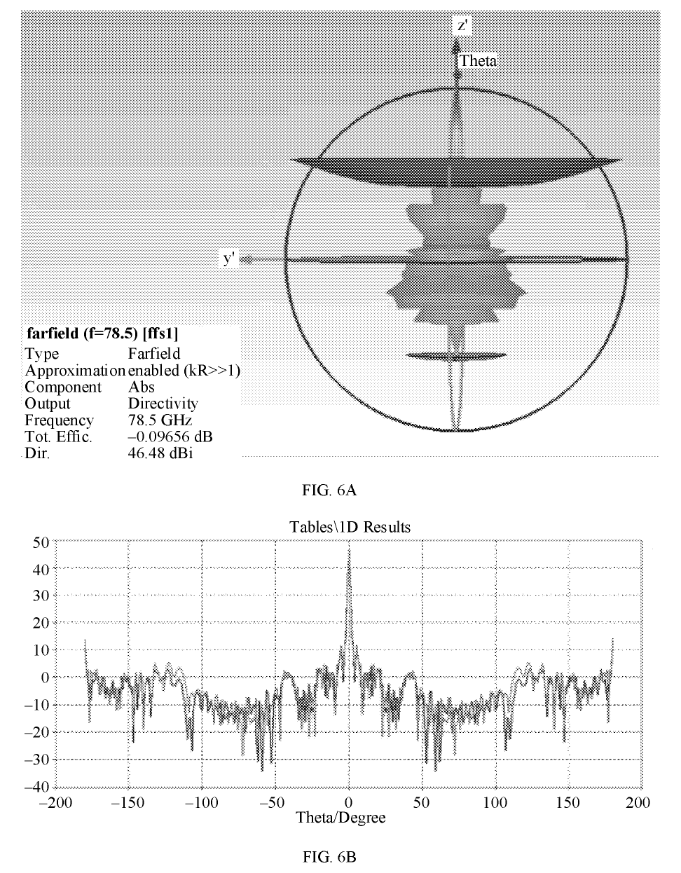

FIG. 6A and FIG. 6B are diagrams of simulation results of the antenna system shown in FIG. 5. Based on the simulation results that, because the millimeter wave feeder and the free space optical radiation source share an aperture and radiation paths are mutually independent (for example, energy radiated by the millimeter wave feeder and wireless light emitted by the free space optical radiation source are not blocked and thus suffer no loss), the millimeter wave and the wireless light emitted by the antenna system can both be radiated out of the antenna system. Therefore, the antenna system has high aperture efficiency, and can obtain a large antenna gain and good directional performance.

When a physical structure size requirement is met, in other words, when a millimeter wave radiation path is not blocked, the millimeter wave feeder and the free space optical radiation source in the example shown in FIG. 5 may be integrated into one communication module, so that the millimeter wave feeder and the free space optical radiation source are conveniently installed at and removed from the hollow center of the millimeter wave lens antenna.

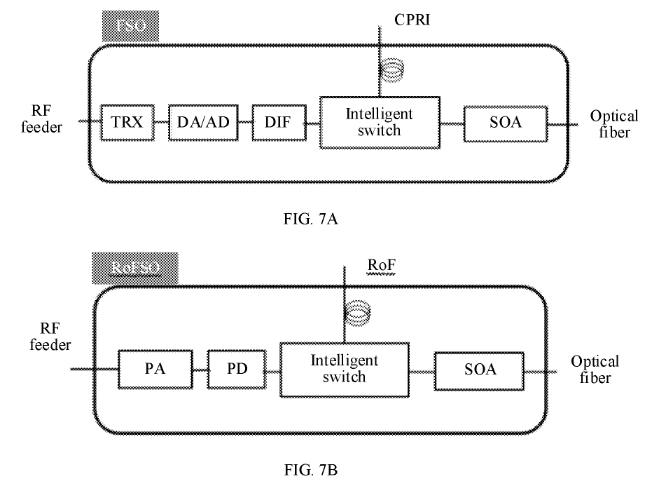

In an example, the communication module integrating the millimeter wave feeder and the free space optical radiation source in the example shown in FIG. 5 is shown in FIG. 7A. The communication module includes a radio frequency feeder (RF feeder) (namely, the millimeter wave feeder), a transceiver (TRX), digital-to-analog conversion or analog-to-digital conversion (DA/AD), a digital intermediate frequency (DIF) signal module, an intelligent switch module, a semiconductor optical amplifier (SOA), and an optical fiber port. The intelligent switch module is connected to a baseband module (for example, a building baseband processing unit (BBU)) through a common public radio interface (CPRI).

In another example, the communication module shown in FIG. 5 is shown in FIG. 7B. The communication module includes a radio frequency feeder (namely, the millimeter wave feeder), a radio frequency amplifier (PA), a photoelectric detector (PD), an intelligent switch module, a semiconductor optical amplifier (SOA), and an optical fiber port. The intelligent switch module is connected to a baseband module (for example, a BBU) through a radio-over-fiber (RoF) communication interface.

In some embodiments, the millimeter wave feeder and the free space optical radiation source have modular characteristics. When function upgrade is performed on the antenna system, the millimeter wave feeder and the free space optical radiation source may be directly replaced, to facilitate function upgrade or module update.

1. An antenna system, comprising:
a first radiation source, a second radiation source, a reflection apparatus, and a first transmission apparatus, wherein a direction of an emitting port of the first radiation source and a direction of an emitting port of the second radiation source are arranged back to back along a same axis, a reflective surface of the reflection apparatus and the first transmission apparatus are arranged opposite to each other, the emitting port of the first radiation source points to the reflective surface of the reflection apparatus, and the first transmission apparatus has a ring-shaped transmission area, wherein
the first radiation source is configured to emit a first signal to the reflective surface of the reflection apparatus;
the reflection apparatus is configured to reflect the first signal to the ring-shaped transmission area of the first transmission apparatus by using the reflective surface;
the first transmission apparatus is configured to radiate, out of the antenna system through the ring-shaped transmission area, the first signal reflected by the reflective surface; and
the second radiation source is configured to emit a second signal, wherein the second signal is radiated out of the antenna system through an area formed based on an inner diameter of the ring-shaped transmission area.

2. The antenna system according to claim 1, wherein the first radiation source is a microwave radiation source, the first signal is a microwave, the second radiation source is a free space optical radiation source, and the second signal is wireless light.

3. The antenna system according to claim 1, wherein the reflective surface is a surface of a solid of revolution formed by rotating a first curve with the axis as a rotation center, and the emitting port of the first radiation source is located at a focus of the first curve.

4. The antenna system according to claim 3, wherein the first curve is a part of an elliptic curve.

5. The antenna system according to claim 4, wherein the emitting port of the first radiation source is located at a first focus of the elliptic curve, and the first signal emitted by the first radiation source passes through a second focus of the elliptic curve after being reflected by the reflective surface.

6. The antenna system according to claim 5, wherein the first transmission apparatus is configured to project the first signal reflected by the reflective surface into a collimated signal, and a focus of the first transmission apparatus coincides with the second focus of the elliptic curve.

7. The antenna system according to claim 1, wherein the antenna system further comprises a second transmission apparatus, the second transmission apparatus is located in the area formed based on the inner diameter of the first transmission apparatus, the emitting port of the second radiation source is located at a focus of the second transmission apparatus, and the second transmission apparatus is configured to project the second signal emitted by the second radiation source into a collimated signal.

8. The antenna system according to claim 1, wherein the antenna system further comprises a first support apparatus, the first support apparatus is configured to support the reflection apparatus and the first transmission apparatus respectively by using two end surfaces that are arranged opposite to each other, the reflection apparatus is located on a first end surface in the two end surfaces that are arranged opposite to each other, the first transmission apparatus is located on a second end surface in the two end surfaces that are arranged opposite to each other, and a periphery of the first transmission apparatus is connected to a periphery of the second end surface.

9. The antenna system according to claim 8, wherein the antenna system further comprises a second support apparatus, and the second support apparatus is configured to support the first radiation source and the second radiation source to be coaxial.

10. The antenna system according to claim 8, wherein the first support apparatus is a cylindrical housing, a bowl-shaped housing, or a disc-shaped housing.

11. The antenna system according to claim 1, wherein the first transmission apparatus comprises any one of a dielectric lens, a planar lens, or a metamaterial lens.

12. The antenna system according to claim 7, wherein the second transmission apparatus comprises any one of a plano-convex lens, a Cassegrain lens, or a Gregorian lens.

13. The antenna system according to claim 1, wherein both the first radiation source and the second radiation source are microwave radiation sources, and both the first signal and the second signal are microwaves.

14. The antenna system according to claim 13, wherein a wavelength of the first signal is different from a wavelength of the second signal.

15. The antenna system according to claim 14, wherein the first signal and the second signal belong to different frequency bands.

16. The antenna system according to claim 14, wherein the wavelength of the first signal is greater than the wavelength of the second signal.

17. The antenna system according to claim 1, wherein the first signal and the second signal are radiated in a same aperture.

18. The antenna system according to claim 17, wherein the first signal and the second signal have different radiation paths.

19. The antenna system according to claim 1, wherein the first radiation source, the second radiation source, the reflection apparatus, and the first transmission apparatus are coaxial.

20. The antenna system according to claim 1, wherein the first signal emitted by the first radiation source entirely arrives in the ring-shaped transmission area of the first transmission apparatus.
